(19) United States
(12) Patent Application Publication
(10) Pub. No.: US 2018/0275869 A1
(43) Pub. Date: Sep. 27, 2018

(54) METHOD, DEVICE, AND TERMINAL FOR DISPLAYING VIRTUAL KEYBOARD

(71) Applicant: Lenovo (Beijing) Co., Ltd., Beijing (CN)

(72) Inventors: Weilong ZHAO, Beijing (CN); Ryohta NOMURA, Beijing (CN); Seiichi KAWANO, Beijing (CN)

(21) Appl. No.: 15/882,377

(22) Filed: Jan. 29, 2018

(30) Foreign Application Priority Data
Mar. 27, 2017 (CN) 201710188828.8

(51) Int. Cl. G06F 3/0488; G06F 3/01; G06F 3/041

(52) U.S. Cl. CPC G06F 3/04886; G06F 3/0414; G06F 3/016

(57) ABSTRACT

Method, device and terminal for displaying virtual keyboard are provided. The method for displaying a virtual keyboard includes: displaying the virtual keyboard on a touch-control screen, the virtual keyboard having a plurality of keys with a three-dimensional (3D) display effect; acquiring a triggering event on the touch-control screen, the triggering event being triggered by a triggering operation on the touch-control screen; based on a location of the triggering event, determining a triggered key of the virtual keyboard; executing a triggering animation of the triggered key, where the triggering animation is a rendered animation that simulates a triggering procedure of a physical key; and inputting key information corresponding to the triggered key.

### CROSS-REFERENCES TO RELATED APPLICATIONS

This application claims priority of Chinese Patent Application No. 201710188828.8, filed on Mar. 27, 2017, the entire contents of which are hereby incorporated by reference.

### TECHNICAL FIELD

The present disclosure generally relates to the technical field of natural language processing and, more particularly, relates to a method, a device, and a terminal for displaying a virtual keyboard.

### BACKGROUND

Virtual touch-screen keyboards are often used in smart mobile terminals, such as a cellphone or pad. A virtual touch-screen keyboard may have integrated functions for both virtual-keyboard-based and hand-writing-based input methods. The virtual touch-screen keyboards can be easy to use, intelligent, and humanized, thereby satisfying various input requirements from the user and enabling large-screen mobile terminals to abandon physical keyboards.

However, due to the small size of the mobile terminal, along with the small size of the touch-control screen, the keys of the virtual keyboard are often smaller than the keys of the physical keyboard. As a result, when using a virtual keyboard, the user has to first accurately locate the positions of the specific keys and then press or click on the keys. This dramatically reduces the speed and accuracy for information input.

### BRIEF SUMMARY OF THE DISCLOSURE

One aspect of the present disclosure provides a method for displaying a virtual keyboard, including: displaying the virtual keyboard on a touch-control screen, the virtual keyboard having a plurality of keys with a three-dimensional (3D) display effect; acquiring a triggering event on the touch-control screen, the triggering event being triggered by a triggering operation on the touch-control screen; based on a location of the triggering event, determining a triggered key of the virtual keyboard; executing a triggering animation of the triggered key; and inputting key information corresponding to the triggered key. The triggering animation is a rendered animation that simulates a triggering procedure of a physical key.

Another aspect of the present disclosure provides a device for displaying a virtual keyboard, including: a memory and a processor coupled to the memory. The memory stores computer readable program instructions, and in response to executing the computer readable program instructions, the processor: displays a virtual keyboard on a touch-control screen, where the virtual keyboard has a plurality of keys with a three-dimensional (3D) display effect; acquires a triggering event on the touch-control screen, the triggering event being triggered by a triggering operation on the touch-control screen; based on a location of the triggering event, determines a triggered key of the virtual keyboard; executes a triggering animation of the triggered key, where the triggering animation is a rendered animation that simulates a triggering procedure of a physical key; and inputs key information corresponding to the triggered key.

Another aspect of the present disclosure provides a terminal for displaying a virtual keyboard, including: a touch-control screen and a device. The device further includes a memory, and a processor coupled to the memory. The memory stores computer readable program instructions, and in response to executing the computer readable program instructions, the processor: displays a virtual keyboard on a touch-control screen; acquires a triggering event on the touch-control screen, the triggering event being triggered by a triggering operation on the touch-control screen; based on a location of the triggering event, determines a triggered key of the virtual keyboard; executes a triggering animation of the triggered key; and inputs key information corresponding to the triggered key. The virtual keyboard has a plurality of keys with a three-dimensional (3D) display effect. The triggering animation is a rendered animation that simulates a triggering procedure of a physical key.

Other aspects of the present disclosure can be understood by those skilled in the art in light of the description, the claims, and the drawings of the present disclosure.

### BRIEF DESCRIPTION OF THE DRAWINGS

From a detailed reading of technical solutions in embodiments of the present disclosure, other objectives and advantages of the present disclosure will become apparent to those ordinarily skilled in the art. Accompanying drawings are merely for descriptive purposes and shall not be construed as limiting of the present disclosure. Throughout accompanying drawings, the same or like reference numerals are used to refer to the same or like parts.

FIG. 1 illustrates a flow chart of an example of a method for displaying a virtual keyboard according to some embodiments of the present disclosure;

FIG. 2 illustrates an example of a virtual keyboard applicable in a cellphone according to some embodiments of the present disclosure;

FIG. 3 illustrates a flow chart of another example of a method for displaying a virtual keyboard according to some embodiments of the present disclosure;

FIG. 4 illustrates an example of a virtual key before and after being pressed according to some embodiments of the present disclosure;

FIG. 5 illustrates a diagram showing an example of a display device for a virtual keyboard according to some embodiments of the present disclosure;

FIG. 6 illustrates a diagram showing another example of a display device for a virtual keyboard according to some embodiments of the present disclosure; and

FIG. 7 illustrates a diagram showing an example of a portion of a virtual keyboard having a three-dimensional (3D) display effect according to some embodiments of the present disclosure.

### DETAILED DESCRIPTION

Various aspects and features of the present disclosure will be described hereinafter with reference to the accompanying drawings. It should be understood that, various modifications may be made to the disclosed embodiments. Thus, the specification shall not be construed as limiting, but is merely intended to illustrate examples of the embodiments. Other modifications obtainable by those skilled in the relevant art shall all fall within the scope and spirit of the present specification.

The present disclosure provides method, device, and terminal for displaying a virtual keyboard. The present disclosure provides improvements on virtual keyboards when being used with touch-control screens. For example, data input efficiency can be improved as the virtual keyboards are displayed and used.

FIG. 1 illustrates a flow chart of an example of a method for displaying a virtual keyboard according to some embodiments of the present disclosure.

In S101, a virtual keyboard is displayed on a touch-control screen.

For example, the virtual keyboard may be used in combination with a touch-control screen. Based on a data input command, the virtual keyboard may be displayed, e.g., popped up, on a designated position of the touch-control screen.

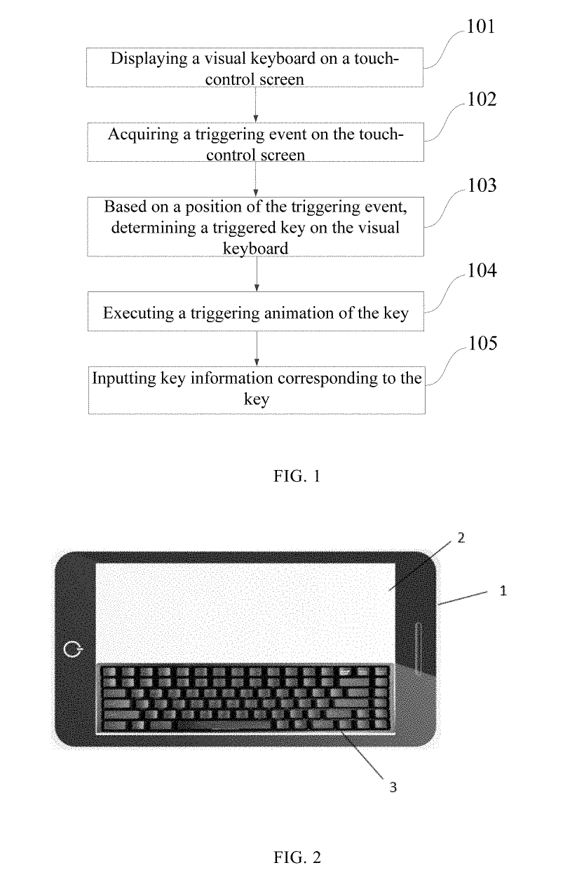

The touch-control screen may be included in a device, a terminal, or any suitable electronic devices. For example, FIG. 2 illustrates a virtual keyboard applicable to a cellphone. Referring to FIG. 2, a cellphone 1 may include a touch-control screen 2, and the touch-control screen 2 may display a virtual keyboard 3 for the user to input information.

The virtual keyboard 3 may be arranged at the bottom region of the touch-control screen 2 in parallel with a length (or longer) side of the touch-control screen 2 in the landscape mode. Alternatively, the virtual keyboard 3 may be arranged at the bottom region of the touch-control screen 2 in parallel with a width (or shorter) side of the touch-control screen 2 in the portrait mode. Any other suitable positions may be used to arrange the virtual keyboard 3.

As used herein, the term “landscape mode” refers to a display mode in which the length (or longer) side of the touch-control screen is horizontal and the width (or shorter) side is vertical, and the term “portrait mode” refers to a display mode in which the length (or longer) side of the touch-control screen is vertical and the width (or shorter) side is horizontal.

Further, the data input command may be a “touch” within the range of a search bar on a user interface (UI), or a click on a search icon or input icon on the touch-control screen, where the “touch” occurs when the user contacts the screen using one or more fingers or a tool, such as a stylus. However, the present disclosure is not intended to limit the data input command to any particular forms.

Further, the display size of the virtual keyboard may be adjusted based on the size of the touch-control screen. In one example, the virtual keyboard may be a Qwerty keyboard, and when the screen in devices such as the cellphone, tablet, electronic book, or pad, for displaying the virtual keyboard is relatively small, the size of the virtual keyboard may be configured to vary as the size of the screen varies. That is, the larger the screen, the larger the correspondingly displayed virtual keyboard. Optionally, when the display mode of the screen changes, e.g., from the landscape mode to the portrait mode, the size of the virtual keyboard may also change correspondingly.

In some other examples, the size of the virtual keyboard may not vary as the size of the screen varies. For example, when a screen is applied to a large-screen device (e.g., an automatic teller machine, ATM, etc.), the screen may need to be sufficiently large. Under such situation, the size of the virtual keyboard integrated on the screen may be the same as or similar to the size of a physical keyboard, which does not change as the size of the screen changes.

Further, the virtual keyboard may have a three-dimensional (3D) display effect shown on a screen, e.g., a touch-control screen. For example, FIG. 7 illustrates a diagram showing a portion of a virtual keyboard having a 3D display effect. As shown in FIG. 7, keys of the virtual keyboard may each have a shadow (also referred to as a “dark area” or “shadow portion”), and the shadow may be represented by a bold line at a bottom of each key to enhance a stereoscopic impression of the key. The weight and width of the bold line at the bottom of each key may be configured based on the layout of the virtual keyboard. Optionally, the shadow may have other shapes and positions, depending on actual demands.

In S102, a triggering event of the touch-control screen is acquired.

The touch-control screen may also be referred to as a touch screen or a touch-control panel. For example, the touch-control screen may be an induction-type liquid crystal display (LCD) device capable of receiving input signals, such as touch or contact. Various touch screens may be encompassed within the scope of the present disclosure and may include: touch screens based on the pressure-vector sensing, touch screens based on the resistor, touch screens based on the capacitor, touch screens based on the infrared (IR) technology, and touch screens based on the surface acoustic wave (SAW). Alternatively, based on the operational principles of the touch screens and the medium used to transmit information, the touch screens may include: resistive touch screen, capacitive touch screen, infrared touch screen, and SAW touch screen.

However, the present disclosure does not intend to limit the types of the touch-control screens, and the user may trigger a corresponding triggering event by performing a touch-control operation on the touch-control screen. In some embodiments, the triggering event may be triggered by a touch-control operation (e.g., click or slide) that the user executes within the display range (e.g., on keys) of the virtual keyboard, such that the character content that the user wants to input may be acquired using the virtual keyboard. The touch-control operation may be, for example, a single or double click on a key, clicks on a plurality of keys, and sliding or swiping using a finger or stylus across the virtual keyboard to input one or more characters.

In S103, based on a location of the triggering event, one or more triggered keys on the virtual keyboard are determined.

In some embodiment, the position of the virtual keyboard on the touch-control screen may be relatively fixed. Thus, based on the location of the triggering event generated by the user's operation on the touch-control screen, whether the triggering event occurs within the virtual keyboard may be determined and, the specific key(s) triggered by the triggering event may be determined. The touch-control screen may have a self-positioning function and any suitable methods for determining the key(s) triggered on the virtual keyboard may be included in the present disclosure.

In S104, a triggering animation is executed for a triggered key.

After a triggered key is determined, a dynamic demonstration of the key being pressed may be executed, that is, the triggering animation of the triggered key is executed. The triggering animation may be a rendered animation that simulates a triggering procedure of a physical key. For example, the triggering animation may be an animation showing a key-pressing-down operation, a popping-up operation, or a combination thereof. However, the present disclosure is not limited thereto, and the user may perform specific configurations based on operation habit or actual demand.

Further, the correlation between executing the triggering animation of the virtual keyboard and executing the triggering operation (e.g., pressing or clicking of a single key) by the user may be defined and configured by the user. For example, the user may configure whether executing the triggering animation of the virtual keyboard and executing the triggering operation by the user are correlated or uncorrelated.

When the user configures that the execution of the triggering animation and the execution of the triggering operation are correlated, the execution speed of the triggering animation may depend on the speed that the user executes the triggering operation. Given the “key-pressing-down” operation as an example, when the user executes the “key-pressing-down” operation on a specific key, the speed of the animation showing the key being pressed may be adjusted based on the force of the “key-pressing-down” operation by the user. Thus, whether the user's operation is a quick click or a long touch may be visually reflected. The quick click may correspond to an animation showing the key being quickly pressed, and the long touch may correspond to an animation showing the key being slowly pressed.

Optionally, the user may configure that the execution of the triggering animation and the execution of a triggering operation are uncorrelated. Under such situation, the triggering animation may be correlated to the triggering event. For example, in response to a triggering event, the triggering animation is executed.

As such, when the execution of the triggering animation is configured to be correlated to the execution of a triggering operation, because the triggering operation needs to be detected in real-time to control the display of the triggering animation, a high amount of system resources may be consumed. Accordingly, the user may select whether or not to correlate the executions of the triggering animation of the virtual keyboard and the triggering operation by the user, based on specific configurations of the smart terminal or smart device.

Further, the triggering animation is configured to correspond to a single key, and each key has a corresponding triggering animation. Accordingly, when the user performs a plurality of triggering operations at substantially the same time, the virtual keyboard may be capable of executing the triggering animations of the plurality of triggering operations at substantially the same time, such that maximized visual response and feedback is provided in response to the user's operations.

In S105, key information corresponding to the triggered key is inputted.

After the triggered key is determined and the corresponding triggering animation is executed, the key information (or character information) corresponding to the triggered key may be inputted to or stored in a corresponding position. Often, the keys on the virtual keyboard often have a one-to-one correspondence relationship with the key information or characters. However, as the pressure or force sensitive touch-control screens are popularized, touch-control operations of the user on a specific point of the touch-control screen with different strengths or forces may correspond to different operation results. For example, pressing on a key with different strengths may correspond to different key information.

The pressing strength of the user when executing a triggering operation may be acquired by the pressure or force sensitive touch-control screen, and different pressing strengths may correspond to different key information. In one example, when the user presses a key on a force-sensitive touch-control screen with different pressing strengths, two different input results are obtained: including an upper-case letter or a lower-case letter. The upper-case letter may be obtained, for example, when the pressing strength equals to or exceed a preset threshold.

As such, the display method of the virtual keyboard may provide 3D display of the virtual keyboard on the touch-control screen of the smart device or smart terminal. Further, when the user performs an operation, triggering animation(s) may be executed on the virtual key(s) in response to the user's operation. The animation may enable the user to virtually receive the feedback responding to the triggering operation, thereby improving the operation accuracy for the user to employ the virtual keyboard for information input.

Further, regarding the inputted content, the user may, via an operation on the same virtual key, determine the input content, thereby enhancing the practicability of the virtual keyboard and enabling the user to accurately input desired character content.

The present disclosure further provides another example of a method for displaying a virtual keyboard. Dynamic display effects of a virtual keyboard may be provided as the user is using the virtual keyboard. Character input result generated by triggering the virtual keyboard may also be provided.

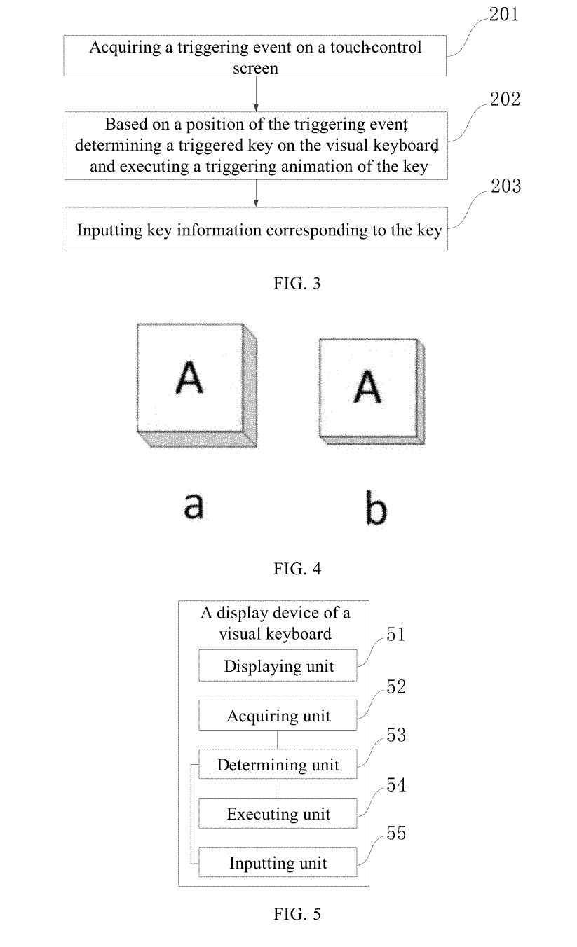

FIG. 3 illustrates a flow chart of another example of a method for displaying a virtual keyboard.

In S201, a triggering event on a touch-control screen is acquired.

For example, the triggering event generated by a user operation may be acquired as a virtual keyboard is displayed on the touch-control screen. Further, when the triggering location of the triggering event occurs within the display range of the virtual keyboard on the touch-control screen, the user's operation is determined to be an effective operation on the virtual keyboard.

As the user uses the virtual keyboard for data input, the operation of the user includes a combined input using a set of keys. For example, the virtual keyboard is often applied by the user to input information including a plurality of characters. Directed towards such application of the virtual keyboard, the present disclosure provides two dynamic display modes, as an example, of the virtual keyboards during the use of the virtual keyboard by the user. It should be noted that, continuous triggering events may exist in both the two dynamic display modes. The user may perform continuous triggering operations on the virtual keyboard, where time intervals between adjacent triggering events are smaller than a preset threshold. Under these conditions, the following dynamic display modes may be selectively triggered. The configuration of such conditions, having time intervals between adjacent continuous triggering events smaller than a preset threshold, enables the user to more accurately recognize the key(s) to be operated on when performing rapid input. The value of the preset threshold may be used for determining the standard of the rapid input by the user, and may be adjusted based on the need or habit of the user.

In mode 1: when the user is determined to be in a status of rapid input, the display area of the keys on the virtual keyboard may be enlarged. The specific implementation may include: when the overall display range of the virtual keyboard is able to be enlarged on the touch-control screen, enlarging the overall display region of the virtual keyboard, such that the display area of each single key is enlarged; and when the display range of the virtual keyboard cannot be enlarged on the touch-control screen, the 3D effect of the virtual keys may be adjusted, for example, the width of the shallow portion in FIG. 2 or FIG. 3 for displaying the 3D effect of the keys may be decreased. By weakening the overall 3D effect of the virtual keys, the display area of each single key may be increased.

As such, by enlarging the display area of the key, the display mode 1 may enable the user to increase the recognition range of the user's operation during the process of rapid input. Accordingly, even when the position of the user's operation shows slight deviation, the virtual keyboard may recognize the user's operation accurately, thereby inputting the character data needed by the user.

In mode 2: the overall display range of the virtual keyboard does not need to be determined or adjusted; however, the display area of one or more keys on the virtual keyboard may be adjusted to achieve similar objectives in the display mode 1. The specific implementation may include: acquiring a triggered key of a current operation by the user, and by data analysis, a key having a correlation relationship with the triggered key is predicted. Further, the number of the keys predicted based on the triggered key may not be limited to one. That is, the number of the keys having a correlation relationship with the triggered key may be one or more.

Further, the display area of the one or more keys having a correlation relationship with the triggered key may be adjusted. For example, specific adjustment of the display area of the one or more keys having a correlation relationship with the triggered key may include increasing the display area of the one or more keys having the correlation relationship with the triggered key, and correspondingly decreasing the display area of the keys surrounding the one or more keys with increased display area that have no correlation relationship with the triggered key. Thus, the positions of the keys having the correlation relationship with the triggered key are highlighted.

Alternatively, the display areas of the one or more keys having the correlation relationship with the triggered key may be increased by weakening the 3D effect of such key(s) without decreasing the display area of the keys surrounding such key(s) that have no correlation relationship with the triggered key. As such, while one or more keys correlated to the triggered key are highlighted, the user may still rapidly find the positions of other keys uncorrelated to the triggered key. That is, further operations on the uncorrelated keys may not be affected.

The above examples of dynamic display modes of the virtual keyboard may be configured for ease of the user's operation to perform rapid input. The dynamic display modes are provided to the user for selection. The user may not necessarily use such display modes, for example, the user may use a normal display mode to perform data input.

In S202, a triggered key on the virtual keyboard is determined based on a location of the triggering event, and a triggering animation of the triggered key is executed.

While S201 illustrates the dynamic display effects of keys on the virtual keyboard, S202 illustrates the dynamic display effect of a single key after being triggered on the virtual keyboard. That is, S202 illustrates the triggering animation executed for a corresponding key after the single key is triggered.

As described previously, the triggering animation is mainly configured for simulating the triggering procedure of a physical key. For example, the triggering procedure may include pressing down and/or popping up the key. That is, the triggering animation may simulate the pressing-down operation or popping-up operation, or their combination of a physical key. Further, for the keys having the 3D display effect, the virtual effects of the animations respectively simulating the pressing-down operation and the popping-up operation of each key may be reversible, which may be implemented through a reversible approach using one or more programs.

The animation effect of the pressing operation of a key is described hereinafter as an example for illustrative purposes.

When the virtual keyboard acquires a pressing-down operation of the user on a specific key, a pressing animation may be executed. Thus, the display effects of the key may be different before and after being pressed. FIG. 4 illustrates an example of a virtual key before and after being pressed. As shown in FIG. 4, “a” represents the display status of the key “A” before being pressed, and “b” represents the display status of the key “A” after being pressed.

For example, the shadow of the key “A” may include a first shadow portion at the bottom of the key “A” and a second shadow portion at the right side of the key “A”, and the first shadow portion and the second shadow portion may each be a parallelogram. Further, a first side of the first shadow portion may be configured to have a substantially the same length as a side of the key “A”, and a second side of the first shadow portion with a relatively short length may form an appropriate angle with respect to the first side of the first shadow portion. The configuration of the second shadow portion is similar to that of the first shadow portion.

When the key “A” changes from the status “a” to the status “b”, e.g., the key “A” is pressed, the shadow portions of the key “A” may become narrower, and the size of the key “A” may become smaller. That is, when the key “A” changes from the status “a” to the status “b”, the first side of the first shadow portion may have a shorter length but still remain substantially the same as a corresponding side of the key “A”, indicating the corresponding side of the key “A” also decreases. Further, the second side of the first shadow portion may become shorter. Similarly, the change in the second shadow portion may refer to the illustrations of the change in the first shadow portion, and related descriptions are thus not provided herein.

Further, when the key “A” changes from the status “a” to the status “b”, because the sides of the key “A” decrease and the overall shape of the key “A” remains substantially the same, the size of the key “A” is also reduced, thereby creating the visual illusion for the user that the key “A” is pressed down and the icon of the key “A” is pushed away from its original position for a certain distance (e.g., about 2 mm).

The pressing animation may refer to the movement of the icon of a key downwards for a first preset distance and movement of the icon of the key to the right for a second preset distance. Further, because the display area of the key icon is reduced, the user may virtually feel that the key is pressed. Optionally, the distance that the key icon is moved downwards and the distance that the key icon is moved to the right may be the same or different. That is, the first preset distance may be the same as or different from the second preset distance.

Further, based on the needs of the animation effect, the key icon may only be moved downwards or the key icon may only be moved to the right, or the icon of the key may be reduced. Optionally, any two of such effects (e.g., movement of the key ion downwards or to the right, and reduce the size of the key icon) may be combined to provide the visual feeling that the key is pressed down.

Referring back to FIG. 4, when the key “A” is popped up, the status of the key “A” may reversibly change from the status “b” to the status “a”. As such, in the present disclosure, reversible triggering animations may be configured for the pressing-down operation and the popping-up operation, respectively.

The operations that the user triggers a key may be divided into two types: click and long press; and whether the user performs click or long press may be recognized, such that different operations may be inputted to obtain different results. In some other embodiments, the click and the long press may not be differentiated, and the animation that combines pressing-down and popping-up may be configured for indicating that the user has clicked a key.

To better notify the user that the virtual keyboard has responded timely to the user's operation, when the triggering animation of a key is executed, a prompt sound and/or a haptic feedback corresponding to the key-pressing may be triggered. The prompt sound may be configured based on the preference of the user, and different prompt sounds may be configured for different keys or different triggering operations by the user.

Further, the haptic feedback may be applied to the smart mobile terminals, for example, the haptic feedback may be a vibration feedback in the cellphone. Similar to the prompt sound, the haptic feedback may also be configured by the user for different keys, thereby more clearly notifying the user about the currently triggered key.

The prompt sound and the haptic feedback may be applied together or individually to the same user terminal. Optionally, based on the user's selection, corresponding functions that trigger the prompt sound and the haptic feedback may be started or shut down, respectively.

In S203, the key information corresponding to the key is inputted.

Based on the recognition of the user's operation, the character information corresponding to the key(s) pressed by the user may be inputted. In an embodiment described previously, in the pressure or force sensitive touch-control screen, different character information corresponding to a pressed key may be inputted based on the pressing force of the user on the screen. That is, a single key may correspond to a certain amount of character information.

Still in S203, the character information corresponding to the key may be determined by recognizing the user's operation, such as click and long press. That is, different user operations on a specific key of the touch-control screen may correspond to different character information. In one embodiment, a single click and a quick double click on the same key may correspond to different character information. For example, the single click on the key “A” of the virtual keyboard may correspond to the lowercase letter “a”, and the double click on the key “A” may correspond to the upper letter “A”. In another embodiment, a quick click and a long press on the same key may correspond to different character information. For example, the quick click on the key “A” of the virtual keyboard may correspond to the lowercase letter “a”, and the long press on the key “A” may correspond to the upper letter “A”.

Such implementations have no requirements on the touch-control screen, that is, the method disclosed herein may not specifically require the touch-control screen to be force-sensitive or pressure sensitive, but may be implemented using normal touch-control screens. Further, to facilitate the application of such virtual keyboard, when a single key corresponds to a certain amount of character information, the certain amount of character information may refer to two characters, thereby facilitating the rapid selection by the user. In other cases, the certain amount of character information may refer to more characters, e.g., more than two, in accordance with various embodiments of the present disclosure.

The present disclosure provides an example of a display device of the virtual keyboard. The device may be used to implement the disclosed methods for displaying a virtual keyboard, e.g., as illustrated in FIGS. 1-4.

FIG. 5 illustrates a diagram showing an example of a display device of a virtual keyboard. Referring to FIG. 5, the display device may include: a displaying unit 51, an acquiring unit 52, a determining unit 53, an executing unit 54, and an inputting unit 55. The display device may be further applied to a smart terminal that employs a touch-control screen.

For example, the displaying unit 51 may be provided for displaying a virtual keyboard on a touch-control screen, where keys on the virtual keyboard have a 3D display effect. The acquiring unit 52 may be provided for acquiring a triggering event on the touch-control screen, where the triggering event is triggered by a user on the touch-control screen. The determining unit 53 may be provided for, based on a location of the triggering event acquired by the acquiring unit 52, determining a triggered key on the virtual keyboard.

Further, the executing unit 54 may be provided for executing a triggering animation of the key determined by the determining unit 53, where the triggering animation is a rendered animation that simulates the triggering procedure of a physical key. The inputting unit 55 may be provided for inputting key information corresponding to the triggered key determined by the determining unit 53.

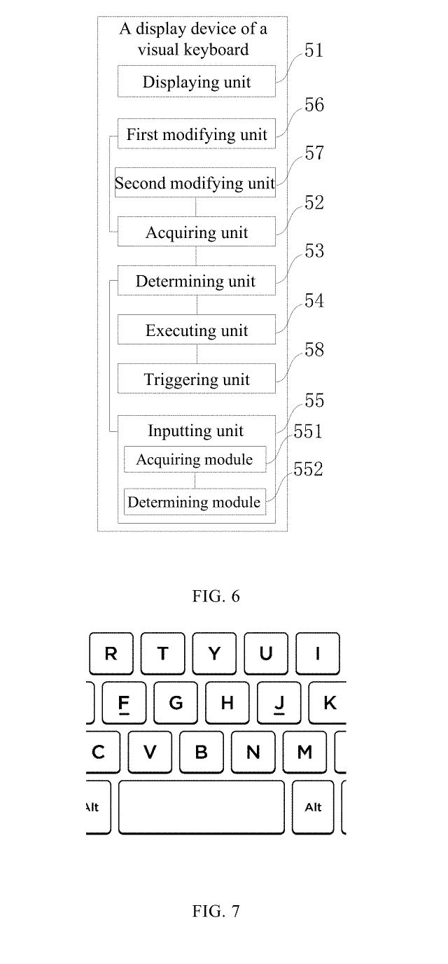

The device may further include other components. For example, FIG. 6 illustrates a diagram showing another example of components of a display device for a virtual keyboard. Compared with the device illustrated in FIG. 5, the device illustrated in FIG. 6 may further include a first modifying unit 56, a second modifying unit 57, and a triggering unit 58. Further, the inputting unit 55 may include an acquiring module 551, and a determining module 552.

The first modifying unit 56 may be provided for, when the acquiring unit 52 acquires continuous triggering events and the time intervals between adjacent triggering events are smaller than a preset threshold, increasing the display area of the keys on the virtual keyboard. The second modifying unit 57 may be provided for, when the acquiring unit 52 acquires the continuous triggering events and the time intervals between adjacent triggering events are smaller than the preset threshold, based on a currently triggered key, determining at least one key correlated to the triggered key and further, enlarging the determined key(s) for display.

Further, the triggering unit 58 may be provided for, when the executing unit 54 executes the triggering animation, triggering a triggering prompt sound corresponding to the key and/or starting a haptic feedback corresponding to the key.

Further, the rendered animation executed by the executing unit 54 may include: a rendered animation of pressing-down of a key, a rendered animation of popping-up of the key, or a combination thereof. Further, the rendered animation of pressing-down of the key executed by the executing unit 54 may include: moving the icon of the key downwards for a first preset distance; and/or moving the icon of the key to the right for a second preset distance; and/or adjusting the size of the icon of the key for display. The first preset distance may be the same as or different from the second preset distance.

Further, as shown in FIG. 6, the inputting unit 55 may include an acquiring module 551, and a determining module 552. The acquiring module 551 may be provided for acquiring the pressing force of a triggering event. Further, because different pressing forces may correspond to different key information, the determining module 552 may be provided for, based on the pressing force acquired by the acquiring module 551, determining the key information corresponding to the key.

Further, the present disclosure provides a display terminal of the virtual keyboard, and the disclosed display device of the virtual keyboard may be configured in the terminal. Further, the terminal may be a smart terminal including a touch-control screen, and the smart terminals may include but not limited to smart cellphone, pad, and various other touch service terminal devices.

As such, the disclosed display method, device, and terminal provide improvement of the display effect of the virtual keyboard. Other than modifying the static display of the virtual keyboard to integrate the 3D effect, the dynamic display of the virtual keyboard is enhanced as the virtual keyboard is being used. Accordingly, when the user uses the virtual keyboard, the response of the virtual keyboard to a user operation on the key may be more clearly received by the user, such that the user may more clearly sense the variance in the display of the key before and after being triggered, thereby improving the accuracy of the user when using the virtual keyboard for information input.

Further, by enhancing the display of the virtual keyboard as the user is in a rapid input status, the accuracy for the user to recognize the key is further improved, thereby accelerating the user's speed in inputting information. Further, while providing desirable virtual experience for the user that uses the virtual keyboard, other types of feedbacks in response to the user's operations, e.g., sound and haptic feedbacks, may be provided to the user. Accordingly, use experience of the virtual keyboard may become similar to or same as for a physical keyboard, which solves technical problems including a poor operation experience of the virtual keyboard, a slow input speed, and a low input accuracy.

The display device of the virtual keyboard may include a processor and a memory. The disclosed displaying unit, acquiring unit, determining unit, executing unit, and inputting unit may all be stored in the memory. The memory stores computer readable program instructions for executing the disclosed methods for displaying virtual keyboard. Further, the processor may execute computer readable program instructions stored in the memory to realize corresponding functions.

Further, the processor may include a kernel, and the kernel may retrieve a corresponding programming unit from the memory. The number of the kernels may be one or more, and by adjusting parameters of the kernel, the dynamic input effect of the virtual keyboard may be implemented, thereby improving the information input efficiency of the virtual keyboard.

The memory may include a non-permanent memory, a random accessible memory (RAM), and/or a non-volatile memory in the computer-readable medium, such as a read-only memory (ROM) or flash memory. The memory may include at least one storage chip.

The present disclosure further provides a computer program product, and when being executed in a data processing device, the computer program product may be applicable to execute initialization of the program codes of the following method: displaying a virtual keyboard on a touch-control screen, where keys on the virtual keyboard have a 3D display effect; acquiring a triggering event on the touch-control screen, and the triggering event includes a triggering operation of a user on the touch-control screen; based on a location of the triggering event, determining a triggered key on the virtual keyboard; executing a triggering animation of the key, where the triggering animation is a rendered animation that simulates the triggering of the key; and inputting key information corresponding to the key.

It should be understood by those skilled in the art that embodiments of the present application may be provided as a method, a device, or a computer program product. Thus, embodiments of the present application may be implemented in the form of a hardware embodiment, a software implementation, or a combination of software and hardware. Moreover, embodiments of the present application may be implemented in the form of a computer program product implemented on one or more computer readable storage medium (including but not limited to disk storage, CD-ROM, optical memory, etc.) containing computer readable program codes.

In a typical configuration, the computer device includes one or more processors (CPUs), input/output interfaces, network interfaces, and a memory. The memory may include a computer readable medium, for example, a non-permanent memory, a random access memory (RAM), and/or a non-volatile memory, such as read-only memory (ROM) or flash memory. Memory is an example of a computer readable medium. The computer readable medium includes both permanent and non-permanent media, and removable and non-removable media which can be implemented by any method or technology to realize information storage. The information may be computer readable instructions, data structures, program modules or other data. Examples of computer storage media include but are not limited to, a phase change memory (PRAM), a static random access memory (SRAM), a dynamic random access memory (DRAM), other types of random access memory (RAM), a read only memory (ROM), an electrically erasable programmable read-only memory (EEPROM), a flash memory or other memory technology, a read-only optical disk read-only memory (CD-ROM), a digital versatile disc (DVD) or other optical storage devices, a cassette magnetic tape, a magnetic tape storage device or other magnetic storage devices or any other non-transmission medium that can be used to store information that can be accessed by a computing device. As defined herein, the computer readable medium does not include non-persistent computer-readable media (i.e., transitory media), such as modulated data signals and carriers.

It should be noted that, terms of “comprising” and “including” or any other variations thereof are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

The sequence numbers of the embodiments of the present invention are merely for ease of description, and do not imply the preference throughout the embodiments.

Through the foregoing description of the implementation manners, it is clear to those skilled in the relevant art that the present disclosure may be implemented by software plus a necessary universal hardware platform, and certainly may also be implemented by hardware, but in many cases, the software implementation is preferred. Based on such an understanding, the technical solutions of the present invention or the part that makes contributions to the existing technology may be substantially embodied in the form of a software product. The apparatus for evaluating a search prompting system are implemented by means of several instructions. The instructions are stored in a storage medium (for example, a ROM/RAM, a magnetic disk, or an optical disc), and instruct a terminal device (which may be a mobile phone, a computer, a server, or a network device) to perform the method according to the embodiments of the present invention.

The above descriptions are merely preferred embodiments of the present disclosure, and are not intended to limit the scope of the present disclosure. Any equivalent modification made to the structure or processes based on content of this specification and the accompanying drawings for direct or indirect use in other related technical fields shall all fall within the protection scope of the present disclosure.

What is claimed is:

1. A method for displaying a virtual keyboard, comprising:
displaying the virtual keyboard on a touch-control screen, the virtual keyboard having a plurality of keys with a three-dimensional (3D) display effect;
acquiring a triggering event on the touch-control screen, the triggering event being triggered by a triggering operation on the touch-control screen;
based on a location of the triggering event, determining a triggered key of the virtual keyboard;
executing a triggering animation of the triggered key, wherein the triggering animation is a rendered animation that simulates a triggering procedure of a physical key; and
inputting key information corresponding to the triggered key.

2. The method according to claim 1, further comprising:
in response to continuous triggering events, having time intervals between adjacent triggering events smaller than a preset threshold:
increasing a display area of the plurality of keys of the virtual keyboard; or
based on a currently triggered key, determining at least one key correlated to the triggered key and enlarging the at least one key for display.

3. The method according to claim 1, further comprising:
in response to executing the triggering animation, triggering one or more of a prompt sound corresponding to the triggered key and a haptic feedback corresponding to the triggered key.

4. The method according to claim 1, wherein executing the triggering animation of the triggered key comprises:
displaying one or more of a rendered animation of key pressing-down and a rendered animation of key popping-up,
wherein the rendered animation of key pressing-down includes one or more of:
moving an icon of the triggered key downwards for a first preset distance;
moving the icon of the triggered key to right for a second preset distance; and
adjusting a size of the icon of the triggered key for display.

5. The method according to claim 1, wherein inputting the key information corresponding to the triggered key comprises:
acquiring a pressing strength of the triggering event; and
based on the pressing strength, determining the key information corresponding to the triggered key.

6. The method according to claim 5, wherein:
different pressing strengths correspond to different key information, and
for the triggered key being a letter key, the key information includes an upper-case letter and a lower-case letter of the letter key.

7. A device for displaying a virtual keyboard, comprising:
a memory; and
a processor, coupled to the memory,
wherein the memory stores computer readable program instructions, and in response to executing the computer readable program instructions, the processor:
displays a virtual keyboard on a touch-control screen, wherein the virtual keyboard has a plurality of keys with a three-dimensional (3D) display effect;
acquires a triggering event on the touch-control screen, the triggering event being triggered by a triggering operation on the touch-control screen;
based on a location of the triggering event, determines a triggered key of the virtual keyboard;
executes a triggering animation of the triggered key, wherein the triggering animation is a rendered animation that simulates a triggering procedure of a physical key; and
inputs key information corresponding to the triggered key.

8. The device according to claim 7, wherein, in response to continuous triggering events, having time intervals between adjacent triggering events smaller than a preset threshold, the processor further:
increases a display area of the plurality of keys of the virtual keyboard; or
based on a currently triggered key, determines at least one key correlated to the triggered key and enlarging the at least one key for display.

9. The device according to claim 7, wherein the processor further:
in response to executing the triggering animation, triggers one or more of a prompt sound corresponding to the triggered key and a haptic feedback corresponding to the triggered key.

10. The device according to claim 7, wherein the processor further:
displays one or more of a rendered animation of key pressing-down and a rendered animation of key popping-up,
wherein the rendered animation of key pressing-down includes one or more of:
moving an icon of the triggered key downwards for a first preset distance;
moving the icon of the triggered key to right for a second preset distance; and
adjusting a size of the icon of the triggered key for display.

11. The device according to claim 7, wherein the processor further:
acquires a pressing strength of the triggering event; and
based on the pressing strength, determines the key information corresponding to the triggered key.

12. The device according to claim 11, wherein:
different pressing strengths correspond to different key information, and
for the triggered key being a letter key, the key information includes an upper-case letter and a lower-case letter of the letter key.

13. A terminal for displaying a virtual keyboard, comprising:
a touch-control screen; and
a device including a memory, and a processor coupled to the memory,
wherein the memory stores computer readable program instructions, and in response to executing the computer readable program instructions, the processor:
displays a virtual keyboard on a touch-control screen, wherein the virtual keyboard has a plurality of keys with a three-dimensional (3D) display effect;
acquires a triggering event on the touch-control screen, the triggering event being triggered by a triggering operation on the touch-control screen;
based on a location of the triggering event, determines a triggered key of the virtual keyboard;
executes a triggering animation of the triggered key, wherein the triggering animation is a rendered animation that simulates a triggering procedure of a physical key; and
inputs key information corresponding to the triggered key.

14. The terminal according to claim 13, wherein, in response to continuous triggering events, having time intervals between adjacent triggering events smaller than a preset threshold, the processor further:
increases a display area of the plurality of keys of the virtual keyboard; or
based on a currently triggered key, determines at least one key correlated to the triggered key and enlarging the at least one key for display.

15. The terminal according to claim 13, wherein the processor further:
in response to executing the triggering animation, triggers one or more of a prompt sound corresponding to the triggered key and a haptic feedback corresponding to the triggered key.

16. The terminal according to claim 13, wherein the processor further:
displays one or more of a rendered animation of key pressing-down and a rendered animation of key popping-up,
wherein the rendered animation of key pressing-down includes one or more of:
moving an icon of the triggered key downwards for a first preset distance;
moving the icon of the triggered key to right for a second preset distance;
adjusting a size of the icon of the triggered key for display.

17. The terminal according to claim 13, wherein the processor further:
acquires a pressing strength of the triggering event; and
based on the pressing strength, determines the key information corresponding to the triggered key.

18. The terminal according to claim 17, wherein:
different pressing strengths correspond to different key information, and
for the triggered key being a letter key, the key information includes an upper-case letter and a lower-case letter of the letter key.
